(19) United States
(12) Patent Application Publication
(10) Pub. No.: US 2015/0302444 A1
(43) Pub. Date: Oct. 22, 2015

(54) SOCIAL ACQUISITION

(71) Applicant: Neelakantan Sundaresan, Mountain View, CA (US)

(72) Inventor: Neelakantan Sundaresan, Mountain View, CA (US)

(21) Appl. No.: 14/258,809

(22) Filed: Apr. 22, 2014

(51) Int. Cl. G06Q 30/02; G06Q 10/10; G06Q 50/00

(52) U.S. Cl. CPC G06Q 30/0214; G06Q 50/01; G06Q 30/0269; G06Q 10/107

(57) ABSTRACT

A system comprising a computer-readable storage medium storing at least one program and a computer-implemented method for acquiring new users through targeted referral requests are presented. Consistent with some embodiments, the method may include accessing a social graph of a group of users, and calculating a social impact rating for each user of the group of users based on the social graph. A referrer user may then be selected from the group of users based on the calculated social impact ratings. A referral request may be generated and transmitted to referrer user. The referral request includes a custom referral offer for the referrer user based in part on the social impact rating of the referrer user. The custom referral offer may include a reward issuable to the referrer user in exchange for referring a new user to a network-based service.

### TECHNICAL FIELD

This application relates to data processing. In particular, example embodiments may relate to systems and methods for acquiring new users through targeted referral requests.

### BACKGROUND

Websites often attempt to acquire new users through referral programs in order to increase a user base and traffic to the website. As part of these referral programs, websites offer current users rewards or incentives for referring new users to the website. As an example, a website may offer users the following: “refer a friend and receive 50 dollars off” Such referral offers are often broadcast to an entire user base without considering whether those users are likely to attempt to refer additional users, or whether those users have the ability to refer additional users. Further, the rewards offered for making referrals are often the same for all users and fail to consider whether such incentives will actually motivate current users to refer new users. As a result, typical referral and acquisition programs have seen limited success in the acquisition of new users or customers.

### BRIEF DESCRIPTION OF THE DRAWINGS

Various ones of the appended drawings merely illustrate example embodiments of the present inventive subject matter and cannot be considered as limiting its scope.

FIG. 1 is a network diagram depicting a network system having a client-server architecture configured for exchanging data over a network with a network-based service, according to an example embodiment.

FIG. 2A is an interaction diagram depicting exchanges between an application server, a third party server, and multiple client devices, consistent with some example embodiments.

FIG. 2B is an interaction diagram depicting further exchanges between an application server, a third party server, and multiple client devices, consistent with some example embodiments.

FIG. 3 is a diagrammatic representation of a social graph of a subject user, consistent with some example embodiments.

FIG. 4 is a block diagram illustrating various functional modules of a social acquisition application, which is provided as part of the networked-based service, consistent with some embodiments.

FIG. 5 is a flowchart illustrating a method for provisioning targeted requests for new user referrals, consistent with some embodiments.

FIG. 6 is a flowchart illustrating a method for calculating a social impact rating of a user, consistent with some embodiments.

FIG. 7 is a flowchart illustrating a method for issuing rewards for successful referrals, consistent with some embodiments.

FIG. 8 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details. In accordance with the present disclosure, components, process steps, and data structures may be implemented using various types of operating systems, programming languages, computing platforms, computer programs, and/or general purpose machines.

Aspects of the present disclosure include a system and methods for acquiring new users through targeted referral requests. As used herein, a “user” may refer to a person (e.g., a human), a business (e.g., a company), an organization, a group of people, a persona (e.g., a fictitious character), a bot, or any combination thereof that utilizes a network-based service. Referral requests may be targeted in the sense that they are sent to particular users whose contacts (e.g., on a social network) may serve as a valuable potential user base. Further, users who are determined to be influential in their respective friend, family, or professional circles may also be targeted by the system for referral requests.

Consistent with some embodiments, a method may include accessing a social graph of a group of users, and calculating a social graph value and social influence score for each user. A referring user may then be selected from the group of users based on a combination of the social graph value and social influence score. The method may further include generating (or selecting) a custom referral offer for the referring user, which may be based on the social graph value, the social influence score, the interests of the user, or any combination thereof. The custom referral offer may include a reward issuable to the referring user in exchange for referring a new user to a network-based service. For example, the custom referral offer for a user interested in art may be “refer a friend and receive 30% off your next purchase of art prints.”

Upon receiving the referral request, the referring user may be motivated by the custom referral offer to refer an additional user. Once the additional user utilizes the network-based service, the referral is deemed complete. Upon successfully completing a referral, the referring user may be issued the reward included as part of the custom referral offer.

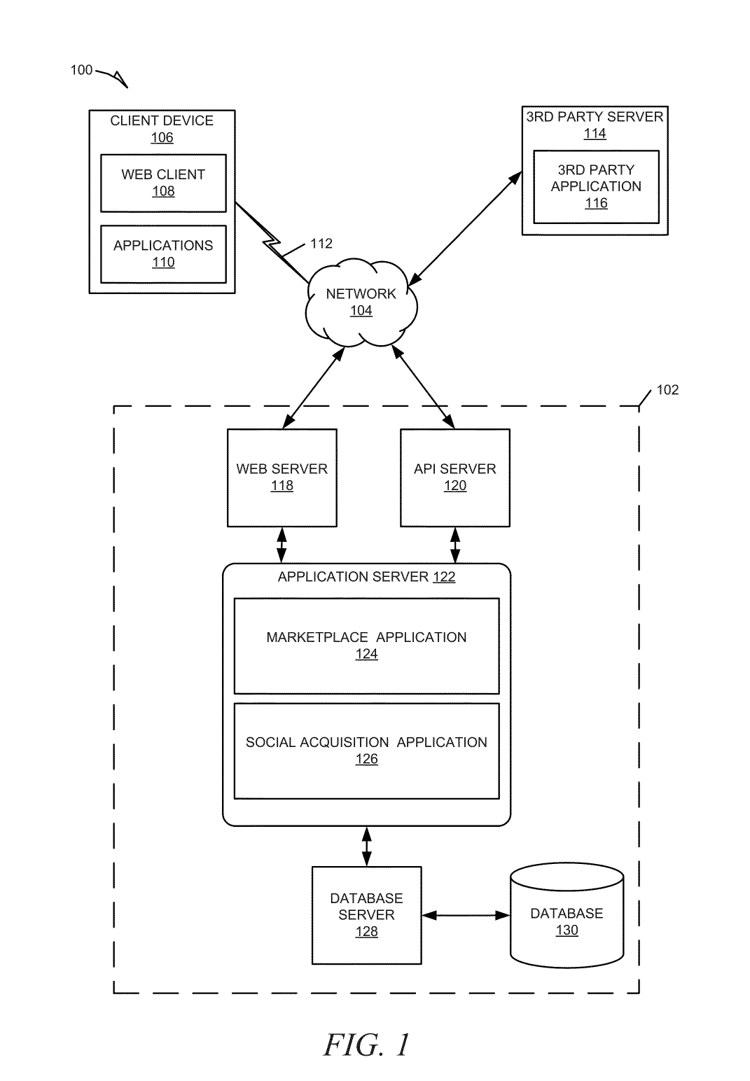

FIG. 1 is a network diagram depicting a network system 100, according to one embodiment, having a client-server architecture configured for exchanging data over a network. The network system 100 may include a network-based service 102 in communication with a client device 106 and a third party server 114. In some example embodiments, the network-based service 102 is a network-based marketplace.

The network-based service 102 may communicate and exchange data within the network system 100 that may pertain to various functions and aspects associated with the network system 100 and its users. The network-based service 102 may provide server-side functionality, via a communication network 104 (e.g., the Internet), to one or more client devices. An example of such devices is the client device 106, which may be operated by users of the network system 100 to exchange data over the communication network 104. These transactions may include transmitting, receiving (communicating), and processing data to, from, and regarding content and users of the network system 100. The data may include, but are not limited to: images; video or audio content; user preferences; product and service feedback, advice, and reviews; product, service, manufacturer, and vendor recommendations and identifiers; product and service listings associated with buyers and sellers; product and service advertisements; auction bids; transaction data; and social data, among other things.

In various embodiments, the data exchanged within the network system 100 may be dependent upon user-selected functions available through one or more client or user interfaces (UIs). The UIs may be associated with a client device, such as the client device 106 using a web client 108. The web client 108 may be in communication with the network-based service 102 via a web server 118. The UIs may also be associated with one or more applications 110 executing on the client device 106, such as a client application designed for interacting with the network-based service 102, or for interacting with the third party server 114 hosting a third party application 116.

The client device 106 may interface with the network-based service 102 via a connection 112 with the communication network 104 (e.g., the Internet or wide area network (WAN)). Depending on the form of the client device 106, any of a variety of types of connection 112 and communication networks 104 may be used. For example, the connection 112 may be code division multiple access (CDMA) connection, a Global System for Mobile communications (GSM) connection, or other type of cellular connection. Such a connection 112 may implement any of a variety of types of data transfer technology, such as single carrier radio transmission technology (1×RTT), Evolution-Data Optimized (EVDO) technology, general packet radio service (GPRS) technology, enhanced data rates for GSM evolution (EDGE) technology, or other data transfer technology (e.g., fourth generation wireless, 4G networks). When such technology is employed, the communication network 104 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or other types of networks).

In another example, the connection 112 may be a wireless fidelity (Wi-Fi, IEEE 802.11x type) connection, a Worldwide Interoperability for Microwave Access (WiMAX) connection, or another type of wireless data connection. In such an embodiment, the communication network 104 may include one or more wireless access points coupled to a local area network (LAN), a WAN, the Internet, or other packet-switched data network. In yet another example, the connection 112 may be a wired connection, for example an Ethernet link, and the communication network 104 may be a LAN, a WAN, the Internet, or other packet-switched data network. Accordingly, a variety of different configurations are expressly contemplated.

FIG. 1 also illustrates the third party application 116 executing on the third party server 114 that may offer one or more services to users of the client device 106. The third party application 116 may have programmatic access to the network-based service 102 via the programmatic interface provided by an application program interface (API) server 120. In some embodiments, the third party application 116 may be associated with any organization that may conduct transactions with or provide services to the users of the client device 106. For example, the third party application 116 may be associated with a social network service (e.g., Facebook®, Twitter®, Google+®, Pinterest®, LinkedIn®, or the like) that may provide a platform for members to build and maintain social networks and relations among other members. Such a social network service may allow members to share ideas, pictures, posts, activities, events, and interests with other members of the social network.

Turning specifically to the network-based service 102, the API server 120 and the web server 118 are coupled to, and provide programmatic and web interfaces respectively to, an application server 122. In some embodiments, the application server 122 may host a marketplace application 124, which may provide a number of marketplace functions and services to users that access the network-based service 102.

As illustrated in FIG. 1, the application server 122 may host a social acquisition application 126 that is responsible for new user acquisition through social network based referrals. For example, the social acquisition application 126 may identify users with an ability to influence members of their social network, and provide such users with customized rewards for referring members of their social network to the network-based service 102.

As illustrated in FIG. 1, the application server 122 may be coupled via the API server 120 and the web server 118 to the communication network 104, for example, via wired or wireless interfaces. The application server 122 is, in turn, shown to be coupled to a database server 128 that facilitates access to a database 130. In some examples, the application server 122 can access the database 130 directly without the need for the database server 128. In some embodiments, the database 130 may include multiple databases that may be internal or external to the network-based service 102.

The database 130 may store data pertaining to various functions and aspects associated with the network system 100 and its users. For example, the application server 122 may host a plurality of user accounts for users of the network-based service 102, which may be stored in the database 130. Each user account may comprise user data that describes aspects of a particular user. The user data may include demographic data, user preferences, and financial information.

The user data may also include a record of user activity, consistent with some embodiments. Accordingly, the network-based service 102 may monitor, track, and record the activities and interactions of a user, using one or more devices (e.g., client device 106), with the various modules of the network system 100. Each user session may be stored in the database 130 as part of an activity log and each user session may also be maintained as part of the user data. Accordingly, in some embodiments, the user data may include past keyword searches that users have performed, web pages viewed by each user, products added to a user wish list or watch list, products added to an electronic shopping cart, and products that the users own.

While the social acquisition application 126 is shown in FIG. 1 to form part of the network-based service 102, it will be appreciated that, in alternative embodiments, the social acquisition application 126 may form part of a service that is separate and distinct from the network-based service 102. Further, while the network system 100 shown in FIG. 1 employs client-server architecture, the present inventive subject matter is, of course, not limited to such an architecture, and could equally well find application in an event-driven, distributed, or peer-to-peer architecture system, for example. The various functional components of the application server 122 may also be implemented as standalone systems or software programs, which do not necessarily have networking capabilities. It shall be appreciated that although the various functional components of the network system 100 are discussed in the singular sense, multiple instances of one of more of the various functional components may be employed.

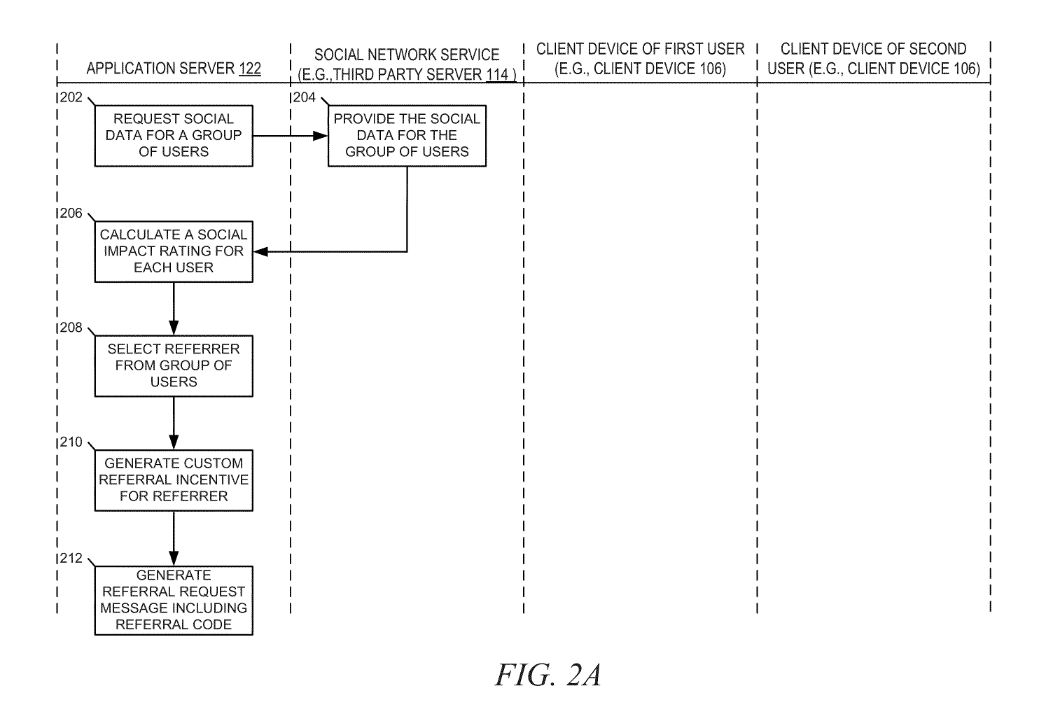

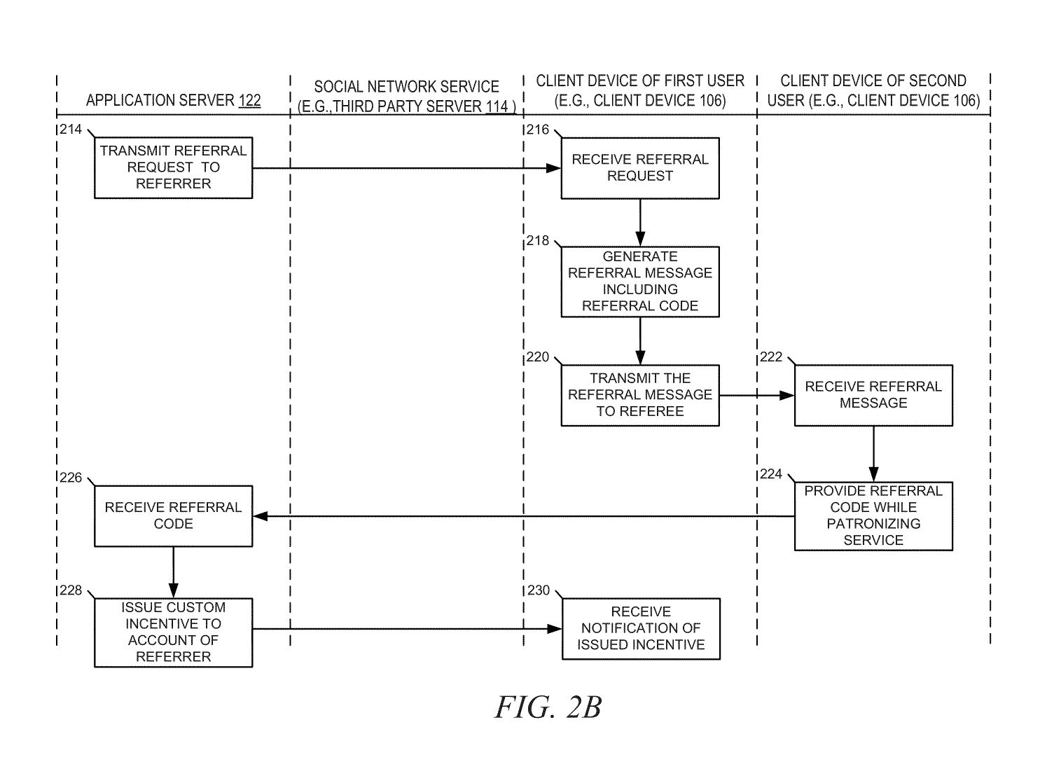

FIGS. 2A and 2B are interaction diagrams showing exchanges between an application server, a third party server, and multiple client devices, consistent with some example embodiments. In particular, FIGS. 2A and 2B depict example exchanges between the application server 122, the third party server 114, which, in this example embodiment, corresponds to a social network service, and two client devices that may, for example, correspond to the client device 106. It shall be appreciated that although FIG. 2 illustrates only a single third party server 114, the exchanges depicted therein may occur between the application server 122 and multiple third party servers 114 hosting different social network services.

As shown in FIG. 2A, at operation 202, the application server 122 may request social data for a group of users (e.g., via API call) from a social network service (e.g., hosted by third party server 114). A social network service, such as the one depicted in FIG. 2A, may provide a representation of each member in the form of a social network profile. The social network profile of each member may contain information about the member (hereinafter referred to as “social data”) such as demographic information (e.g., age, gender, income level, relationship status, employment status, or household size), geographic information (e.g., a user's hometown, a user's current location), interests, and social network connections of the members. A social network “connection,” also referred to as being “connected” on a social network, refers to a relationship between two members of a social network. For purposes of the present disclosure, a social network “connection” may include situations in which there is a reciprocal agreement between members of the social network to be linked on the social network, as well as situations in which there is only a singular acknowledgement of the “connection” without further action being taken by the other member. In the reciprocal agreement situation, both members of the “connection” acknowledge the establishment of the connection (e.g., friends). Similarly, in the singular acknowledgement situation, a member may elect to “follow” or “watch” another member. In contrast to a reciprocal agreement, the concept of “following” another member typically is a unilateral operation because it may not call for acknowledgement or approval by the member that is being followed.

The social data may further include a record of social network activity for each user of the social network service. For purposes of the present disclosure, “social network activity” collectively refers to social actions performed by users using a social network services. Social actions may include creating, sharing, and interacting with social network entries (e.g., text and image postings, links, messages, notes, and invitations). Social actions may be published as one or more social network entries that may be shared with and by other members of the social network. Such social network activities may involve entries that are intended for the public at large as well as entries intended for a particular social network connection or group of social network connections. Depending on the social network, the social network activity may include, for example, social actions such as a request to be linked on the social network, an activity feed post, a wall post, a status update, a tweet, a pinup, a like, a content share (e.g., content shared from a source such as the network-based service 102), or a check-in.

For purposes of the present disclosure, a “check-in” refers to a service provided by a social network that allows users to “check in” to a physical space or virtual space and share their location with other users of the social network. Consistent with some other embodiments, users may check in to a specific location by using a mobile application (e.g., application 110) provided by the social network on a client device (e.g., client device 106). The social network mobile application may use the GPS functionality of the client device 106 to find the current location of the user and allow the user to share this information with other members of the social network.

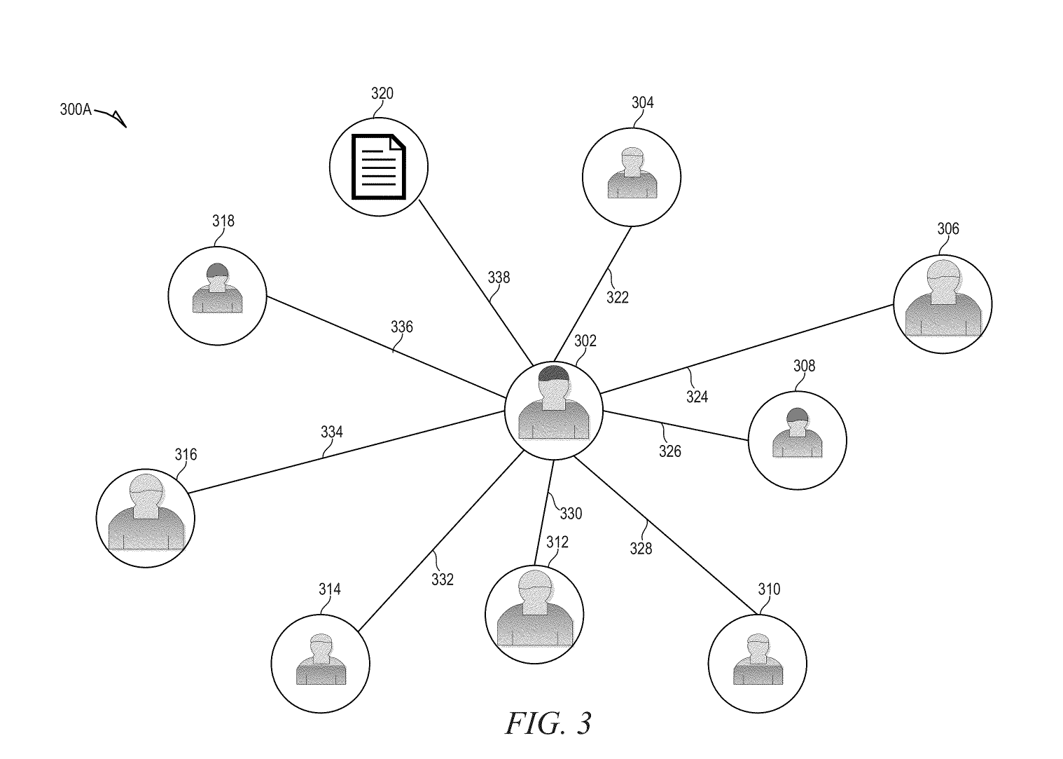

The social data may further include a social graph. A social graph is a data structure representing social network relations (e.g., social network connections) of users. Social graphs traditionally include nodes representing people (e.g., members of a social network), places (e.g., geo-graphic locations, websites or webpages), and things (e.g., content, events, applications), and edges representing the relationships between nodes. FIG. 3 is a diagrammatic representation of an example social graph 300A of a subject user, consistent with some embodiments. As illustrated in FIG. 3, the social graph 300A may include nodes 302-320, and edges 322-338. The node 302 represents the subject user (e.g., the user for whom the relationships of the social graph are represented). Each of the nodes 304-320 may represent a social network object, and each of the edges 322-338 may represent the subject user 302's relationship with the social network objects.

A social network object refers to an element or entity that a user may have a relationship with based on one or more interactions with the element or entity facilitated by one or more social network services. For example, the nodes 304-318 correspond to members of a social network to which the subject user 302 belongs. The edges 330-344 represent the relationships of the subject user 302 as social network connections (e.g., “friends,” or “followers”) of the social network members represented by nodes 304-318. Further, the node 320 corresponds to a content item the subject user 302 has a relationship with, which is represented by the edge 338. A subject user's relationships with a content item may arise from the subject user's social network activity, including, for example, viewing the content item, creating a social network post referencing the content item, “liking” or “pinning” the content item, or creating the content item. As used herein, the term “content item” refers to electronic data that is consumed by viewers (e.g., users) on displays, client devices 106, or other page/display-based media (e.g., World-Wide Web (WWW) media embodied in browsers and accessible over the Internet). As such, the term “content item” may refer to data associated with readable text, data associated with images, data associate with graphics or video, programmatic content, scripts, or data corresponding to various combinations of these.

Returning to FIG. 2A, at operation 204, the social network service may provide the social data for the group of users to the application server 122. At operation 206, the application server 122 may calculate a social impact rating for each user of the group of users based on the social data obtained from the social network service(s). The social impact rating is a combined measure of the value of a user's social graph (e.g., to the network-based service 102) and the influence of the user over said social graph. In other words, the social impact rating provides a measure of the likelihood that a user will be able to bring in (e.g., refer) valuable new users to the network-based service 102.

At operation 208, the application server 122 may select a user from the group of users as a referrer. As used herein, the term “referrer,” “referrer user,” or “referring user” refers to a user who has provided or may provide a recommendation to another user (hereinafter referred to as the “referee,” “referee user,” or “referred user”) to join, subscribe to, or otherwise patronize the network-based service 102. The selection of the referrer may be based on the social impact rating of the referrer. For example, the application server 122 may select the user with the highest social impact rating as the referrer.

At operation 210, the application server may generate a custom referral offer for the referrer. The custom referral offer includes a monetary reward such as a coupon, discount, or other monetary incentive that may be issued to the referrer in exchange for successfully referring a new user (e.g., the referred user) to the network-based service 102. The referral offer may be customized in the sense that the coupon, discount, or other monetary reward is specifically tailored for the referrer based on the social data about the referrer (e.g., interests) obtained from the social network service, the user data (e.g., transaction history) maintained by the network-based service 102 as part of the user account of the referrer, or a combination of both. In some embodiments, the custom referral offers may be unique to each user. In some other embodiments, the custom referral offers are selected from a list of pre-defined offers, wherein the selection of the particular offer from the list of pre-defined offers is based on information about the user to whom it is being offered. In an example, a coupon “save $20 on Fishing Gear when you refer a friend” may be generated for the referrer based on the referrer having listed “fishing” as an interest in his social network profile. In another example, a coupon “buy one book, get the second book free when you refer a friend” may by generated for the referrer based on the referrer having previously purchased multiple books through the marketplace application 124.

At operation 212, the application server may generate a referral request for the referrer. The referral request may be a message that requests the referrer to refer additional users (e.g., “refer a friend”), identifies the custom referral offer (e.g., “and get $25 toward the purchase of concert tickets”), and includes a referral code. The referral code is a unique code or identifier corresponding to the custom referral offer of the referrer. The referral code may be used by the referred user to confirm that his or her patronage is a result of a referral by the referrer. In some embodiments, the referral request may identify and request the referral of a particular social network connection or group of social network connections included in the social graph of the referrer user.

Moving on to FIG. 2B, at operation 214, the application server 122 transmits the referral request to the client device of the referrer (e.g., the client device 106). At operation 216, the referral request is received by the client device of the referrer. The referrer may then be motivated by the custom referral offer to compose a referral message suggesting or requesting patronage of the network-based service 102 by one or more users selected from his or her social graph, at operation 218. The referral message may further include the referral code. At operation 220, the referrer may cause (e.g., by using the client device 106) the referral message to be transmitted to the client device of a referee.

At operation 222, the client device of the referee receives the referral message. Upon reading the referral message, the referee may be inspired to use the network-based service 102. While patronizing the network-based service 102, the referee user may provide the referral code (e.g., an appropriate text field) that was included in the referral message, at operation 224. At operation 226, the application server 122 may receive the referral code from the referred user. In response to receiving the referral code, the application server 122 may issue the custom reward (e.g., included in the custom referral offer) to a user account (e.g., maintained by the network-based service 102) of the referrer, at operation 228. At operation 230, the client device of the referrer may receive a notification of the issuance of the reward.

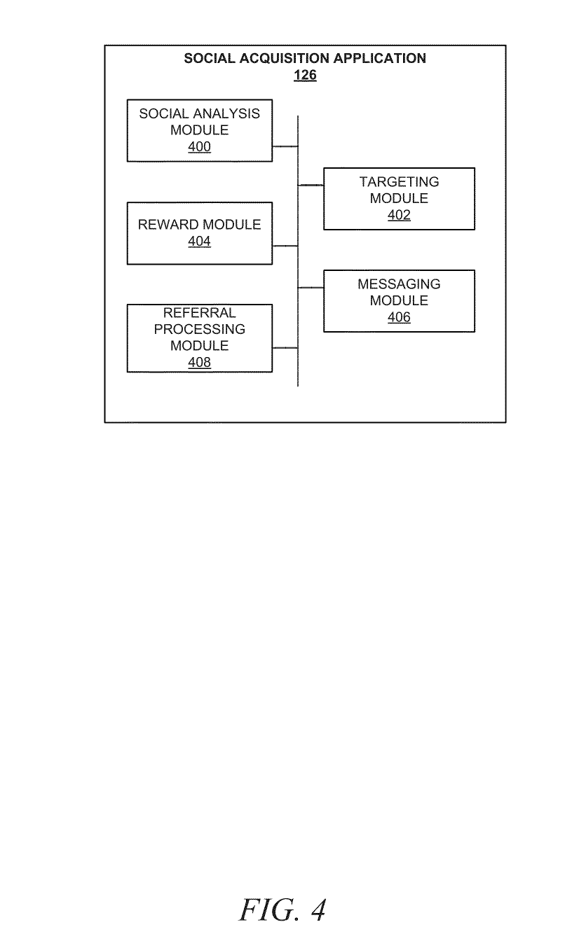

FIG. 4 is a block diagram illustrating various functional modules of a social acquisition application 126, which is provided as part of the networked-based service 102, consistent with some embodiments. The social acquisition application 126 is shown as including a social analysis module 400, a targeting module 402, an reward module 404, a messaging module 406, and a referral processing module 408, all configured to communicate with each other (e.g., via a bus, shared memory, a switch, or application programming interfaces (APIs)). The various modules of the social acquisition application 126 may, furthermore, access one or more of the databases 130 via the database servers 128, and each of the various modules of the social acquisition application 126 may be in communication with one or more of the third party applications 116 (e.g., a social network service). Further, while the modules of FIG. 4 are discussed in the singular sense, it will be appreciated that in other embodiments multiple modules may be employed.

The social analysis module 400 may be configured to retrieve and analyze social data about users from one or more social networks. In particular, the social analysis module 400 may analyze social data to compute a social impact rating for users. The social impact rating of a user is determined using a combination of the value of the user's social graph to the network-based service 102, and the user's ability to influence the social graph. As such, the social analysis module 400 may determine a social influence score and a social graph value for each user.

The targeting module 402 may be configured to identify and select users who are referral candidates. Such users may be sent a referral request with custom offers to refer new users to the network-based service 102. The targeting module 402 may select users based on the social impact rating determined by the social analysis module 400, consistent with some embodiments. In some instances, the targeting module 402 may also select one or more suggested referees from the social graph of a referrer user based on social data about those users.

The reward module 404 is responsible for producing custom referral offers for referring users. The custom referral offers produced by the reward module 404 are to serve the purpose of enticing would-be referrers to refer friends or other contacts to the network-based service 102. The referral offers may be customized for each referring user based on the interests and activities of the user as represented by corresponding social data and user data. The referral rewards may, for example, include coupons, discounts, redeemable loyalty points, or other types of monetary incentives. Each customized referral offer has a corresponding referral code, which is a unique identifier used to process referrals. Consistent with some embodiments, the value of such rewards may be based on the user's social graph value, social influence score, or a combination of both (e.g., the social impact rating).

The custom referral offers produced by the reward module 404 may be uniquely generated for each user, consistent with some embodiments. In alternative embodiments, the custom referral offers may be selected by the reward module 404 from a collection of pre-defined referral offers based on information about the user. In this manner, the custom referral offers may still be tailored to users as information about the users is being taken into account when selecting an offer, however, the computational expense of generating individually unique offers for each user is greatly reduced.

The messaging module 406 is responsible for the generation and delivery of messages to users of the network-based service 102, such as messages requesting new user referrals from users (e.g., referral requests). The messaging module 406 may utilize any one of a number of message delivery networks and platforms to deliver messages to users. For example, the messaging module 406 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

The referral processing module 408 is responsible for processing referrals and issuing referral rewards. The referral processing module 408 may receive a referral code from a referred user at some point during the referred user's patronage of the network-based service 102 (e.g., during checkout or while establishing an account). The referral processing module 408 may use the referral code to identify the referring user and the rewards provided as part of a custom referral offer, which the referral processing module 408 may then issue to an account of the referring user or directly to the referring user. Upon issuance of the referral reward, the referral processing module 408 may work in conjunction with the messaging module 406 to provide the referring user with a notification of the issuance of the referral reward. In some embodiments, the referral processing module 408 may process referrals and issue rewards without the need of a referral code, and may do so using an identifier (e.g., name, customer number, or email address) of the referring user, which may also be provided by the referred user.

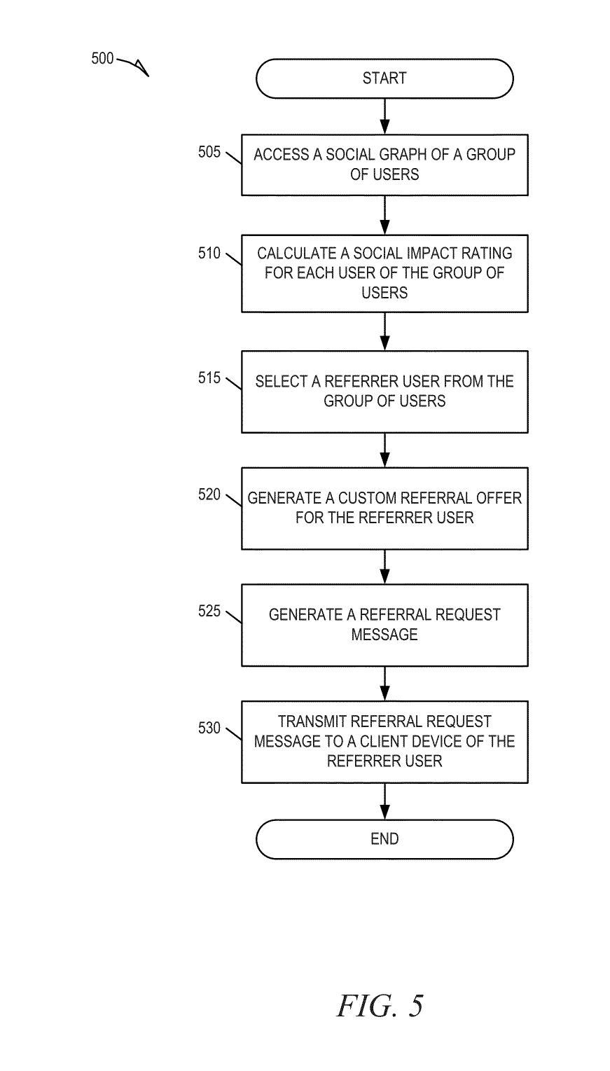

FIG. 5 is a flowchart illustrating a method 500 for provisioning targeted requests for new user referrals, consistent with some embodiments. The method 500 may be embodied in computer-readable instructions for execution by one or more processors such that the method 500 may be carried out in whole or in part by the network-based service 102. In particular, the method 500 may be carried out by the modules forming the social acquisition application 126, and accordingly, the method 500 is described below by way of example with reference thereto. However, it shall be appreciated that the method 500 may be deployed on various other hardware configurations and is not intended to be limited to the modules of the social acquisition application 126.

At operation 505, the social analysis module 400 may access social data about a group of users. The social data may include each user's social graph. At operation 510, the social analysis module 400 may calculate a social impact rating for each user of the group of users. The social impact rating is a combined measure of the user's social graph value and social influence score. As such, the social impact rating provides an indication of capability of a particular user to refer valuable other users to the network-based service 102. Consistent with some embodiments, the social impact rating of a user may be based on a number of social network connections in the social graph of the user that are not current users of the network-based service (also referred to as “non-users”). Further, the analysis module 400 may take into account the social graphs of the social connections of the users when determining the social impact rating. For example, a user with only a few social network connections whose social graphs are comprised of a number of non-users may be determined to have a higher social impact rating than a user with several social network connections whose social graphs are comprised of very few non-users.

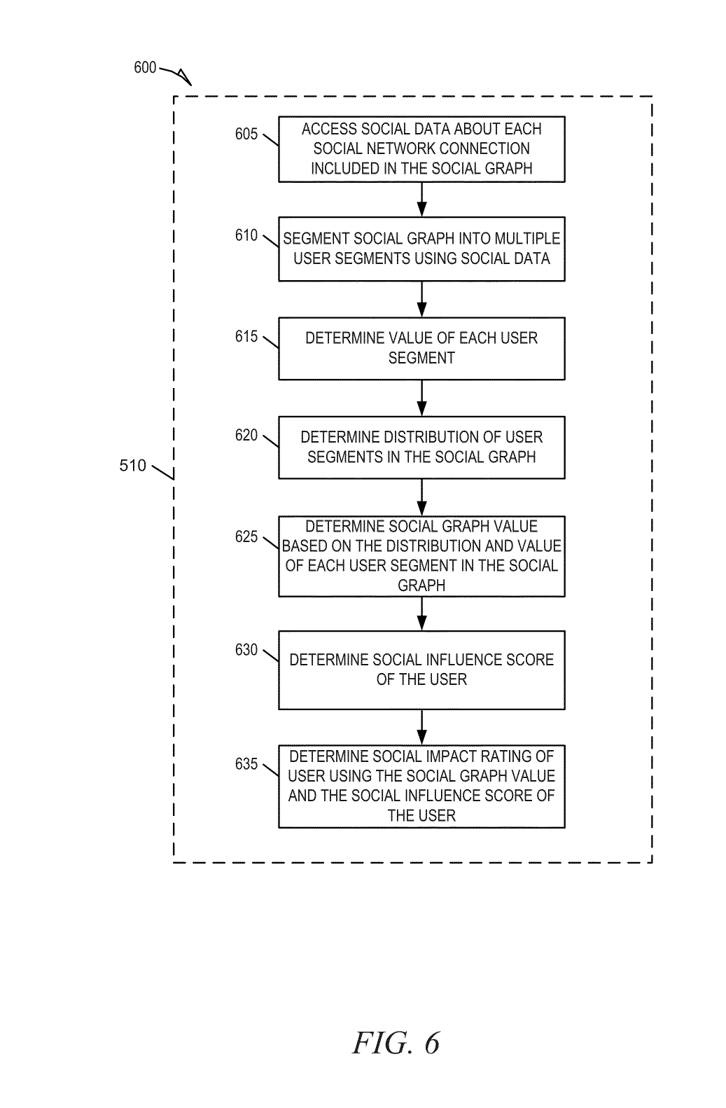

The social impact rating may also be based on other factors such as the interests of the social network connections in the social graph of the user, a cumulative amount of purchases made by the social network connections in the social graph of the user, an amount or frequency of social actions performed by the user that result in an action being taken by one or more social network connections of the user, or an income level of the social network connections in the social graph of the user. Further details of the operation 510 are discussed below in reference to FIG. 6.

At operation 515, the targeting module 402 may select a referrer user from the group of users based on the social impact rating of each of the group of users. For example, the targeting module 402 may select the user with the highest social impact rating as the referrer user. In some instances, the targeting module 402 may weight one component of the social impact rating (e.g., the social graph value or the social influence score) more highly when selecting the referrer user from the group of users. For example, the targeting module 402 may select the user with the highest social graph value from the group of users as the referrer user, although the user did not have the highest overall social impact rating.

In some embodiments, the selection of the referrer user from the group of users may be based on the social graph of the user having a favourable distribution of members within a particular user segment. For example, the targeting module 402 may select a particular user as the referrer user by virtue of the social graph of the particular user being comprised primarily of high value users, as determined by the income levels of the users (e.g., as indicated by or inferred from social data from a social network service).

At operation 520, the reward module 404 may generate a custom referral offer for the referrer user. The referral offer may be customized based on information about the user from the social data retrieved at operation 505 or from the user data about the referrer user maintained by the network-based service 102. The custom referral offer may include one or more rewards directed to the referrer user. In an example, the reward module 404 may generate a reward provided as part of a custom referral offer to “refer a friend and receive free movie tickets” based on the social data about the user indicating that the referred user is a film enthusiast. In another example, the reward module 404 may generate a reward provided as part of a custom referral offer to “refer a friend and receive $15 toward the purchase of your next vinyl record” based on transaction history (e.g., included in the user data) of the referrer user including several past purchases of vinyl records.

In some embodiments, the referral reward's value may vary based on the social graph value of the referrer user. For example, a first user may be provided a referral reward to “refer a friend and receive $10” based on the first user having a relatively low social graph value, whereas a second user may be provided a referral reward to “refer a friend and receive $50” based on the second user having a relatively high social graph value.

In some embodiments, the custom referral offer generated by the reward module 404 at operation 520 may be directed at a specific referee user. For example, the reward module 404 may generate a custom referral offer for a referrer user to “refer your friend Sam Johnson and receive $10 off your next purchase.” The reward module 404 may work in conjunction with the social analysis module 400 to select a referee user based on an estimated value of the referee to the network-based service 102. The estimated value may be based on publically available social data about the referee.

At operation 525, the messaging module 406 may generate a referral request for the referrer user. The referral request identifies the custom referral offer generated specifically for the referrer user, and includes a request that the referrer user refer an additional user (e.g., a friend). The referral request may further include a referral code, and may also include link to be used in facilitating the referral. Consistent with some embodiments, the referral request may specify a suggested referee whom the referrer user should refer in order to receive the custom referral offer. The suggested referee may be selected by the targeting module 402 from the social graph of the referrer user based on social data (e.g., interests or demographic data) about the suggested referee. At operation 530, the messaging module 406 may transmit the referral request to a client device (e.g., client device 106) of the referrer user, or to a messaging account (e.g., an email account) of the referrer user.

FIG. 6 is a flowchart illustrating a method 600 for calculating a social impact rating of a user, consistent with some embodiments. Consistent with some embodiments, the method 600 corresponds to the operation 510 of method 500, and may be performed for each user of the group of users. The method 600 may be embodied in computer-readable instructions for execution by one or more processors such that the method 600 may be carried out in whole or in part by the network-based service 102. In particular, the method 600 may be carried out by the social analysis module 400, and accordingly, the method 600 is described below by way of example with reference thereto. However, it shall be appreciated that the method 600 may be deployed on various other hardware configurations and is not intended to be limited to the social analysis module 400.

At operation 605, the social analysis module 400 may access social data about each social network connection included in a social graph of a user. The social data includes demographic information (e.g., age, gender, income level, relationship status, employment status, or household size), geographic information (e.g., a user's hometown, a user's current location), interests, and social network activity for each user. At operation 610, the social analysis module 400 may segment the social graph of the user into multiple user segments based on the social data about each user. In an example, the social analysis module 400 may segment the users comprising the social graph into “high value users,” “moderate value users,” and “low value users.” In this example, the determination of which segment a particular user included in the social graph is placed into may be based on the income level of the user or other suitable metrics such as known affinities for items in certain price categories.

The multiple user segments may be predefined or determined dynamically based on the social data about the users comprising the social graph. In some embodiments, the multiple user segments may correspond to categories of products offered for sale through the marketplace application 124. In an example, the social analysis module 400 may segment the users comprising the social graph into segments for “fashion,” “automotive,” and “collections” based on the respective interests of the users (e.g., as indicated by the social data) comprising the social graph falling within one of those categories.

Consistent with some embodiments, the segmentation performed by the analysis module 400 may take into account only those social network connections of the user that are not users or members of the network-based service while ignoring the social network connections that are current users of the network-based system. In some embodiments, the analysis module 400 may first segment the social graph into users and non-users of the social network service. Further segmentation of the non-users (e.g., sub-segments) in accordance with the methodologies discussed above may then be performed at operation 610.

At operation 615, the social analysis module 400 may determine a value of each of the multiple user segments. The value of each of the multiple user segments refers to a predicted or perceived worth of the user segment to the network-based service 102. The determination of the value of each user segment performed by the social analysis module 400 may be based on historical transaction information maintained by the network-based service 102. Consistent with some embodiments, the determination of the value of a given user segment may depend on the number of non-users of the network-based service 102 in the user segment.

At operation 620, the social analysis module 400 may determine the distribution of each user segment in the social graph of the user. For example, the social analysis module 400 may determine that the social graph of the user has a 50% distribution of “high value users,” a 35% distribution of “moderate value users,” and a 15% distribution of “low value users.” The social analysis module 400 may further determine a distribution of non-users in each of the user segments.

At operation 625, the social analysis module 400 may determine a social graph value based on the distribution (e.g., determined at operation 620) and the value (e.g., determined at operation 615) of each user segment in the social graph. The social graph value refers to the value (or worth) of a social graph to the network-based service 102. Consistent with some embodiments, the social graph value may be an aggregate, average, or other statistical summation of the values of the user segments using the distribution as a weighting. In some embodiments, the social graph value may be based on the distribution of non-users of the network-based service 102 in each user segment.

At operation 630, the social analysis module 400 may determine a social influence score of the user. The social influence score provides a measure of the ability of the user to influence members of his or her social graph. The determination of the social influence score may be based on a number of factors including, but not limited to, an amount of time the user has been active on a social network service, a frequency with which the user uses the social network service (e.g., how frequently an account is accessed), a number of social network connections in the social graph of the user, a number of social networks to which the user belongs, an amount or frequency with which the user interacts with members of his or her social graph (e.g., through direct messages or wall posts), an amount or frequency with which members of the social graph have performed an action in response to a social action performed by the user (e.g., comments in response to a status update, or “liking” or “retweeting” a post), or a number of purchases resulting from the user have shared a product. At operation 635, the social analysis module 400 may determine a social impact rating for the user using a combination of the social graph value and the social influence score of the user.

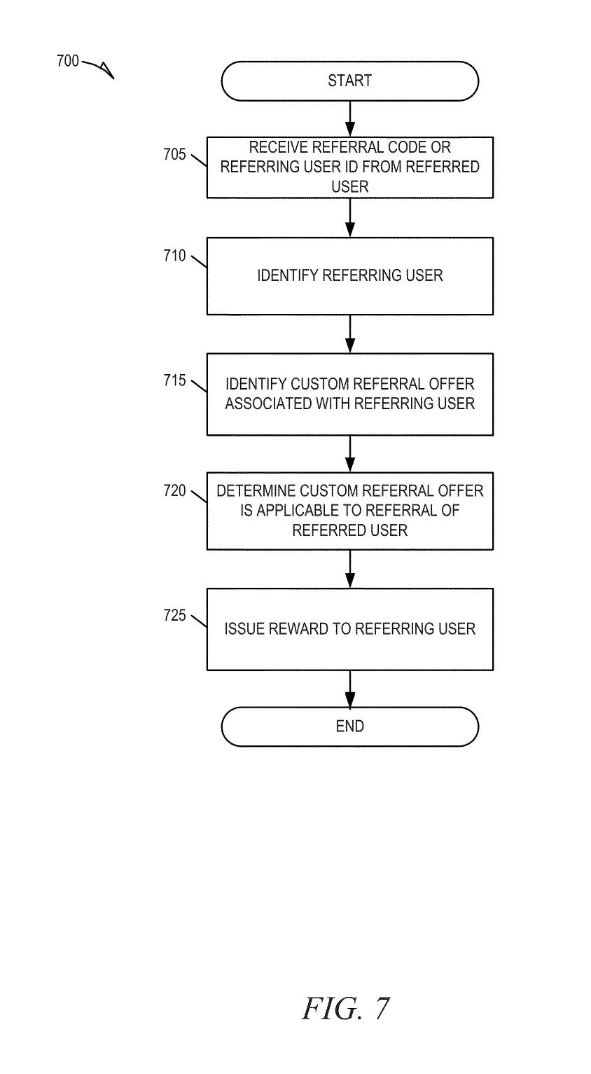

FIG. 7 is a flowchart illustrating a method 700 for issuing rewards for fulfilled referrals, consistent with some embodiments. The method 700 may be embodied in computer-readable instructions for execution by one or more processors such that the method 700 may be carried out in whole or in part by the network-based service 102. In particular, the method 700 may be carried out by the referral processing module 408, and accordingly, the method 700 is described below by way of example with reference thereto. However, it shall be appreciated that the method 700 may be deployed on various other hardware configurations and is not intended to be limited to the modules of the referral processing module 408.

At operation 705, the referral processing module 408 may receive a referral code or referring user identifier (e.g., email address, account number, or user name) from a referred user. The referral code or referring user identifier may be received from the referred user while the referred user patronizes or otherwise interacts with the network-based service 102. At operation 710, the referral processing module 408 may identify the user responsible for the referral (e.g., the referring user) based on the referral code or referring user identifier.

In some instances, a single user may have had multiple custom referral offers generated by the reward module 404 that are only applicable to the referral of a certain user, set of users, or classification of users. At operation 715, the referral processing module 408 may identify a custom referral offer associated with the referring user. The custom referral offer may include an reward such as a coupon, a discount, an account credit, or other monetary incentive. At operation 720, the referral processing module 408 may determine that the identified custom referral offer is applicable to the referral of the referred user. At operation 725, the referral processing module 408 may issue the reward provided by the custom referral offer to the referring user in response to the referring user having referred another user (e.g., the referred user). The issuing of the referral reward may include crediting an account of the user, or providing the referred user with a coupon or reward code for later fulfillment. The custom referral offer may be redeemable by the network-based service 102, or another third-party service.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as an FPGA or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of these. Example embodiments may be implemented using a computer program product, for example, a computer program tangibly embodied in an information carrier, for example, in a machine-readable medium, for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

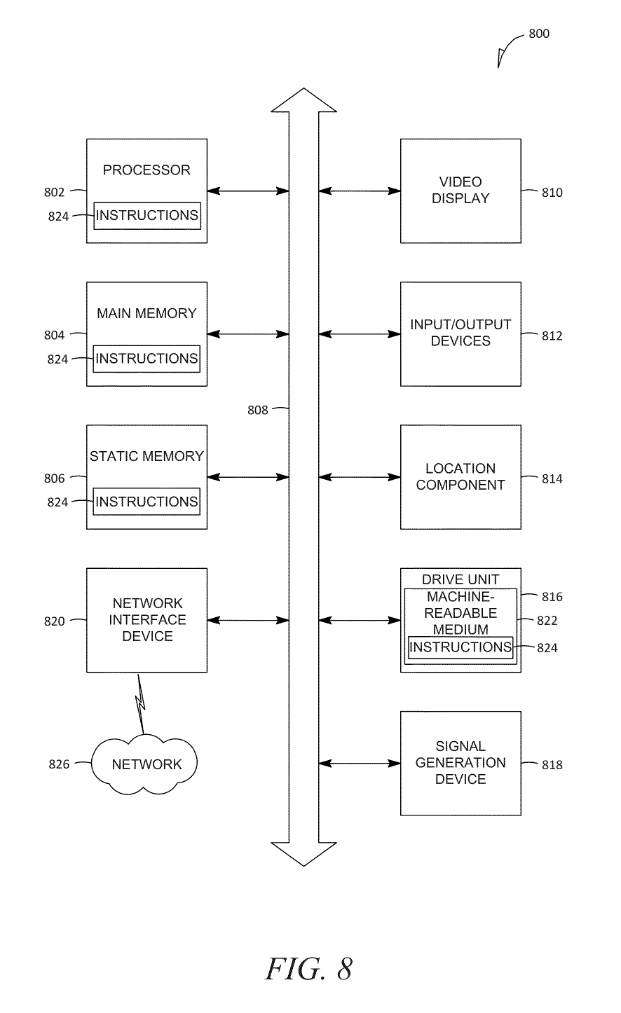

FIG. 8 is a diagrammatic representation of a machine in the example form of a computer system 800 within which a set of instructions for causing the machine to perform any one or more of the methodologies discussed herein may be executed. The computer system 800 may correspond to the client device 106, the third party server 114, or the application server 122, consistent with some embodiments. The computer system 800 may include instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804, and a static memory 806, which communicate with each other via a bus 808. The computer system 800 may further include a video display 810 (e.g., a liquid crystal display (LCD) or a cathode ray tube (CRT)). The computer system 800 also includes one or more input/output (I/O) devices 812, a location component 814, a drive unit 816, a signal generation device 818 (e.g., a speaker), and a network interface device 820. The I/O devices 812 may, for example, include a keyboard, a mouse, a keypad, a multi-touch surface (e.g., a touchscreen or track pad), a microphone, a camera, and the like.

The location component 814 may be used for determining a location of the computer system 800. In some embodiments, the location component 814 may correspond to a GPS transceiver that may make use of the network interface device 820 to communicate GPS signals with a GPS satellite. The location component 814 may also be configured to determine a location of the computer system 800 by using an internet protocol (IP) address lookup or by triangulating a position based on nearby mobile communications towers. The location component 814 may be further configured to store a user-defined location in the main memory 804 or the static memory 806. In some embodiments, a mobile location enabled application may work in conjunction with the location component 814 and the network interface device 820 to transmit the location of the computer system 800 to an application server 122 or third party server 114 for the purpose of identifying the location of a user operating the computer system 800.

In some embodiments, the network interface device 820 may correspond to a transceiver and antenna. The transceiver may be configured to both transmit and receive cellular network signals, wireless data signals, or other types of signals via the antenna, depending on the nature of the computer system 800.

### Machine-Readable Medium

The drive unit 816 includes a machine-readable medium 822 on which is stored one or more sets of data structures and instructions 824 (e.g., software) embodying or used by any one or more of the methodologies or functions described herein. The instructions 824 may also reside, completely or at least partially, within the main memory 804, the static memory 806, and/or the processor 802 during execution thereof by the computer system 800, with the main memory 804, the static memory 806, and the processor 802 also constituting machine-readable media.

Consistent with some embodiments, the instructions 824 may relate to the operations of an operating system (OS). Depending on the particular type of the computer system 800, the OS may, for example, be the iOS® operating system, the Android® operating system, a BlackBerry® operating system, the Microsoft® Windows® Phone operating system, Symbian® OS, or webOS®. Further, the instructions 824 may relate to operations performed by applications 110 (commonly known as “apps”), consistent with some embodiments. One example of such an application 110 is a mobile browser application that displays content, such as a web page or a user interface using a browser.

While the machine-readable medium 822 is shown, in an example embodiment, to be a single medium, the term “machine-readable medium” may include a single medium or multiple media (e.g., a centralized or distributed database, and/or associated caches and servers) that store the one or more data structures or instructions 824. The term “machine-readable medium” shall also be taken to include any tangible medium that is capable of storing, encoding, or carrying instructions (e.g., the instructions 824) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory including, by way of example, semiconductor memory devices (e.g., erasable programmable read-only memory (EPROM) and electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium as “non-transitory” should not be construed to mean that the medium is incapable of movement; the medium should be considered as being transportable from one real-world location to another. Additionally, since the machine-readable medium is tangible, the medium may be considered to be a machine-readable device.

### Transmission Medium

The instructions 824 may further be transmitted or received over a network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying the instructions 824 for execution by the machine, and includes digital or analog communications signals or other intangible media to facilitate communication of such software.

Although the embodiments of the present inventive subject matter have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels, and are not intended to impose numerical requirements on their objects.

What is claimed is:

1. A system comprising:
a processor of a machine;
a social analysis module configured to access a social graph for each user of a group of users, the social graph representing social network connections of the group of users, the social analysis module further configured to calculate, using the processor of the machine, a social impact rating for each user of the group of users based in part on the social graph of each user;
a targeting module configured to select a referrer user from the group of users based on the social impact ratings; and
a messaging module configured to generate a referral request including a custom referral offer for the referrer user, the custom referral offer including a reward issuable to the referrer user in exchange for referring a new user to a network-based service, the messaging module further configured to transmit the referral request to a client device of the referrer user.

2. The system of claim 1, further comprising a reward module configured to generate the custom referral offer for the referrer user based on social data about the referrer user retrieved from one or more social networks.

3. The system of claim 1, wherein the messaging module transmits the referral request via electronic mail (email).

4. The system of claim 1, wherein the targeting module is further to select a suggested referee user from the social graph of the referrer user based on social data about the suggested referee.

5. The system of claim 4, wherein the referral request includes an identifier of the suggested referee.

6. The system of claim 1, further comprising a referral processing module to process a referral made by the referrer user, the referral processing module further to issue the reward to the referrer user in response to determining that the referrer user has referred a new user.

7. A method comprising:
accessing a social graph for each user of a group of users, the social graph representing social network connections of the group of users;
calculating, using a processor of a machine, a social impact rating for each user of the group of users based in part on the social graph of each user;
selecting a referrer user from the group of users based on the social impact ratings;
generating a referral request including a custom referral offer for the referrer user, the custom referral offer including a reward issuable to the referrer user in exchange for referring a new user to a network-based service; and
transmitting the referral request to a client device of the referrer user.

8. The method of claim 7, further comprising issuing the reward to the referrer user in response to determining that the referrer user has referred a new user.

9. The method of claim 8, wherein the referral request includes a referral code associated with the referrer user and with the custom referral offer, and wherein the determining that the referrer user has referred the additional user is based on receiving the referral code while the additional user is utilizing the network-based service.

10. The method of claim 7, wherein the calculating of the social impact rating for each user of the group of users comprises:
accessing social data about each social network connection included in the social graph;
segmenting the social network connections into multiple user segments based on the social data;
determining a distribution of the user segments in the social graph;
determining a value of each of the user segments to the network-based service; and
determining a social graph value based on the distribution and value of the user segments in the social graph.

11. The method of claim 7, wherein the calculating of the social impact rating for each user of the group of users comprises determining a social influence score for each user, the social influence score indicating an influence of each user over that user's social graph.

12. The method of claim 11, wherein the determining of the social influence score is based on a frequency of social actions performed by each user that result in action being taken by the social network connections comprising the respective social graph of each user.

13. The method of claim 7, wherein the selecting of the referrer user is based on the referrer user having the highest social impact rating of the group of users.

14. The method of claim 10, wherein the selecting of the referrer user is based on the referrer user having the highest social graph value of the group of users.

15. The method of claim 7, wherein the custom referral offer is selected from a collection of pre-defined referral offers.

16. The method of claim 7, wherein the reward is a coupon or discount.

17. The method of claim 7, wherein a value of the reward is based on the social graph value of the referrer user.

18. The method of claim 7, wherein the referral request includes a request for a referral of a particular social network connection from the social graph of the referrer user.

19. The method of claim 7, wherein the custom referral offer is further based on interests of the referrer user as defined by social data about the referrer user retrieved from one or more social network services.

20. A tangible machine-readable storage medium having no transitory signals, and embodying instructions that, when executed by a machine, cause the machine to perform operations comprising:
accessing a social graph for each user of a group of users, the social graph representing social network connections of the group of users;
calculating a social impact rating for each user of the group of users based in part on the social graph of each user;
selecting a referrer user from the group of users based on the social impact ratings;
generating a referral request including a custom referral offer for the referrer user based in part on the social impact rating of the referrer user, the custom referral offer including a monetary incentive issuable to the referrer user in exchange for referring a new user to a network-based service; and
transmitting the referral request to a client device of the referrer user.
